(19) United States
(12) Patent Application Publication
(10) Pub. No.: US 2019/0176531 A1
(43) Pub. Date: Jun. 13, 2019

(54) Pneumatic Tire

(71) Applicant: The Yokohama Rubber Co., LTD., Minato-ku, Tokyo (JP)

(72) Inventor: Takahisa Murata, Hiratsuka-shi, Kanagawa (JP)

(21) Appl. No.: 16/306,530

(22) PCT Filed: May 19, 2017
(86) PCT No.: PCT/JP2017/018889

§ 371 Date: Nov. 30, 2018

(30) Foreign Application Priority Data
May 30, 2016 (JP) 2016-107030

(51) Int. Cl. B60C 11/03; B60C 11/01; B60C 11/12; B60C 11/13

(52) U.S. Cl. CPC B60C 11/0311; B60C 11/01; B60C 2200/14; B60C 11/1236; B60C 11/1353; B60C 11/1204

(57) ABSTRACT

A pneumatic tire includes first lug grooves and second lug grooves shorter than the first lug grooves provided alternately along a circumferential direction in a shoulder region of a tread section, a first connection groove that connects the second lug groove and a tip end part of the first lug groove, and a second connection groove that connects the first lug groove and a tip end part of the second lug groove. An angle of the first connection groove is greater than an angle of the second connection groove, and an inner end portion in the lateral direction of each of first shoulder blocks, each defined by the first lug groove, the second lug groove, and the first connection groove, is disposed closer to the equator side than an inner end portion in the lateral direction of each of second shoulder blocks.

### TECHNICAL FIELD

The present technology relates to a pneumatic tire, and more specifically, relates to a pneumatic tire capable of improving uneven wear resistance and driving performance on muddy road surfaces, and achieving a good balance of both of these performance properties in a compatible manner.

### BACKGROUND ART

With pneumatic tires that are used for driving on muddy ground, snow covered roads, and sandy soil, etc. (hereinafter, collectively referred to by the generic phrase “muddy ground, etc.”), ordinarily, tires having a large groove surface area with a tread pattern configured with primarily of blocks and lug grooves having a large amount of edge components are adopted. This type of tire is configured to obtain traction performance by biting into mud, snow, and sand, etc. (hereinafter, collectively referred to by the generic phrase “mud, etc.”) on road surfaces, to prevent the mud, etc. from being packed into the grooves (increase discharge performance of mud, etc.), and to improve driving performance on muddy ground, etc. (mud performance) (see Japan Patent No. 4537799, for example).

However, uneven wear tends to easily occur with this type of tread pattern configured with primarily of blocks. In particular, when the groove surface area is increased to improve mud performance, block rigidity decreases, resulting in a decrease of uneven wear resistance, and thus a problem is that it is difficult to achieve both mud performance and uneven wear resistance in a compatible manner. Therefore, a demand exists for a countermeasure that improves both mud performance and uneven wear resistance in a compatible manner, and achieves a good balance of both of these performance properties even with patterns configured primarily of blocks.

### SUMMARY

The present technology provides a pneumatic tire capable of improving uneven wear resistance and driving performance on muddy road surfaces, and of achieving a good balance of both of these performance properties in a compatible manner.

A pneumatic tire of the present technology includes an annular tread section extending in a tire circumferential direction, a pair of sidewall sections disposed at both sides of the tread section, and a pair of bead sections disposed inward in the tire radial direction of the sidewall sections. The pneumatic tire includes a plurality of first lug grooves and a plurality of second lug grooves shorter than the first lug grooves, the first lug grooves and the second lug grooves extending in a tire lateral direction in a shoulder region of the tread section, and being alternately disposed along the tire circumferential direction, a first connection groove extending from a tip end portion of the first lug groove to the second lug groove, and a second connection groove extending from a tip end portion of the second lug groove to the first lug groove, wherein an angle of the first connection groove with respect to the tire circumferential direction is larger than an angle of the second connection groove with respect to the tire circumferential direction, each of a plurality of first shoulder blocks is defined by the first lug groove, the second lug groove, and the first connection groove, each of a plurality of second shoulder blocks is defined by the first lug groove, the second lug groove, and the second connection groove, an inner end portion in the tire lateral direction of the first shoulder block is disposed closer to a tire equator side than an inner end portion in the tire lateral direction of the second shoulder block, and each of the first shoulder blocks and second shoulder blocks includes a traversal groove traversing each block while inclining with respect to the tire circumferential direction.

As described above, with the present technology, first lug grooves, second lug grooves, first connection grooves, and second connection grooves are provided, and first shoulder blocks and second shoulder blocks are defined by these grooves, and therefore mud discharge performance for discharging mud, etc. from inside the grooves with good efficiency can be increased while obtaining excellent traction performance with excellent biting into the mud, etc., and mud performance can be improved. In particular, as described above, because the angle of the first connection groove with respect to the tire circumferential direction is larger than the angle of the second connection groove with respect to the tire circumferential direction, the traction performance of the second lug grooves, which have relatively low traction performance due to being shorter than the first lug grooves, can be compensated by the first connection grooves, and the mud discharge performance of the first lug grooves, which have relatively low mud discharge performance due to being longer than the second lug grooves, can be compensated by the second connection grooves, and the mud performance can be effectively increased. Meanwhile, traversal grooves are provided for each of the first shoulder blocks and the second shoulder blocks, and therefore the first shoulder blocks and the second shoulder blocks are suitably defined, a difference in rigidity between these blocks can be suppressed, and uneven wear resistance can be increased.

In the present technology, preferably, the traversal groove is disposed at a position having same distances from each outer edge in the tire lateral direction of the first shoulder block and the second shoulder block. When the traversal grooves are disposed in this manner, the rigidity of portions at the outer side in the tire lateral direction defined by the traversal grooves of the first shoulder blocks and the second shoulder blocks can be made substantially equal, and such a configuration is advantageous for increasing uneven wear resistance.

At this time, the first shoulder block includes a concave part at a ground contact edge position, and an outer edge in the tire lateral direction of the first shoulder block is positioned further inward in the tire lateral direction than the ground contact edge position. Accordingly, when the position of the traversal groove with respect to the first shoulder block and the second shoulder block has the distances from the edge at the outer side in the tire lateral direction of each block to be same, traversal grooves formed at adjacent blocks in the tire circumferential direction can be shifted. Such a configuration is advantageous for achieving a favorable balance of block rigidity and increasing uneven wear resistance.

In the present technology, each angle of the first lug groove and the second lug groove with respect to the tire circumferential direction at the ground contact edge position is preferably 60° to 90° at the acute angle side. By setting the angle of each lug groove in this manner, traction performance in the shoulder region can be improved, which is advantageous for increasing mud performance.

Preferably, the present technology further includes a plurality of third connection grooves connecting first connection grooves positioned at both sides of the tire equator and a plurality of fourth connection grooves connecting second connection grooves positioned at both sides of the tire equator, wherein a plurality of center blocks is defined on the tire equator by the first connection grooves, the second connection grooves, the third connection grooves, and the fourth connection grooves. Accordingly, traction performance by the third connection grooves and the fourth connection grooves can be ensured in the center region, and such a configuration is therefore advantageous for increasing mud performance.

At this time, preferably, an angle of the third connection groove with respect to the tire circumferential direction is smaller than an angle of the fourth connection groove with respect to the tire circumferential direction. Accordingly, mud discharge performance can be improved with respect to the third connection grooves that are connected to the first connection grooves, which excel in traction performance, and traction performance can be improved with respect to the fourth connection grooves that are connected to the second connection grooves, which excel in mud discharge performance, and therefore mud performance can be exhibited at an advanced level through the combination of these first to fourth connection grooves.

In the present technology, the center block includes a center sipe extending along the second connection groove. Accordingly, the rigidity of the center block portion, where rigidity easily increases due to being positioned on an extension line of the second lug groove, which has a short groove length, is suppressed, a difference in block rigidities of the second lug groove and near the second connection groove is suppressed, and uneven wear resistance can be increased. Furthermore, an edge effect through the sipes can be anticipated, and therefore traction performance can also be improved.

At this time, preferably, the first shoulder blocks includes a first shoulder sipe extending along the second lug groove, the second shoulder block includes a second shoulder sipe extending along the second lug groove, and the center sipe, the first shoulder sipe, and the second shoulder sipe are arranged as a series of sipes to surround the second lug groove. Accordingly, a favorable balance in the rigidity of particularly the second lug groove peripheral edge portion of the first shoulder blocks, the second shoulder blocks, and the center blocks can be achieved, and thus such a configuration is advantageous for increasing uneven wear resistance. Furthermore, an edge effect through the sipe can be anticipated, and therefore such a configuration is also advantageous for increasing traction performance.

In the present technology, the tire ground contact edge is the end portion in the tire axial direction when the tire is mounted on a regular rim, inflated to a regular internal pressure, and placed vertically upon a flat surface with a regular load applied thereto. The region between the ground contact edges of both sides in the tire lateral direction is referred to as “ground contact region”. “Regular rim” is a rim defined by a standard for each tire according to a system of standards that includes standards on which tires are based, and refers to a “standard rim” in the case of JATMA (Japan Automobile Tyre Manufacturers Association, Inc.), refers to a “design rim” in the case of TRA (The Tire and Rim Association, Inc.), and refers to a “measuring rim” in the case of ETRTO (The European Tyre and Rim Technical Organisation). “Regular internal pressure” is an air pressure defined by standards for each tire according to a system of standards that includes standards on which tires are based, and refers to a “maximum air pressure” in the case of JATMA, refers to the maximum value in the table of “TIRE ROAD LIMITS AT VARIOUS COLD INFLATION PRESSURES” in the case of TRA, and refers to the “INFLATION PRESSURE” in the case of ETRTO. “Regular internal pressure” is 180 kPa for a tire on a passenger vehicle. “Regular load” is a load defined by standards for each tire according to a system of standards that includes standards on which tires are based, and refers to “maximum load capacity” in the case of JATMA, refers to the maximum value in the table of “TIRE ROAD LIMITS AT VARIOUS COLD INFLATION PRESSURES” in the case of TRA, and refers to “LOAD CAPACITY” in the case of ETRTO. If the tire is for use with a passenger vehicle, a load corresponding to 88% of the loads described above is used.

### BRIEF DESCRIPTION OF DRAWINGS

FIG. 1 is a meridian cross-sectional view of a pneumatic tire according to an embodiment of the present technology.

FIG. 2 is a front view illustrating a tread surface of the pneumatic tire according to an embodiment of the present technology.

FIG. 3 is a main portion enlarged view illustrating the first and second shoulder blocks of FIG. 2.

FIG. 4 is an explanatory diagram illustrating the arrangement of traversal grooves.

FIG. 5 is a main portion enlarged view illustrating the center blocks of FIG. 2.

### DETAILED DESCRIPTION

Configurations of embodiments of the present technology are described in detail below with reference to the accompanying drawings.

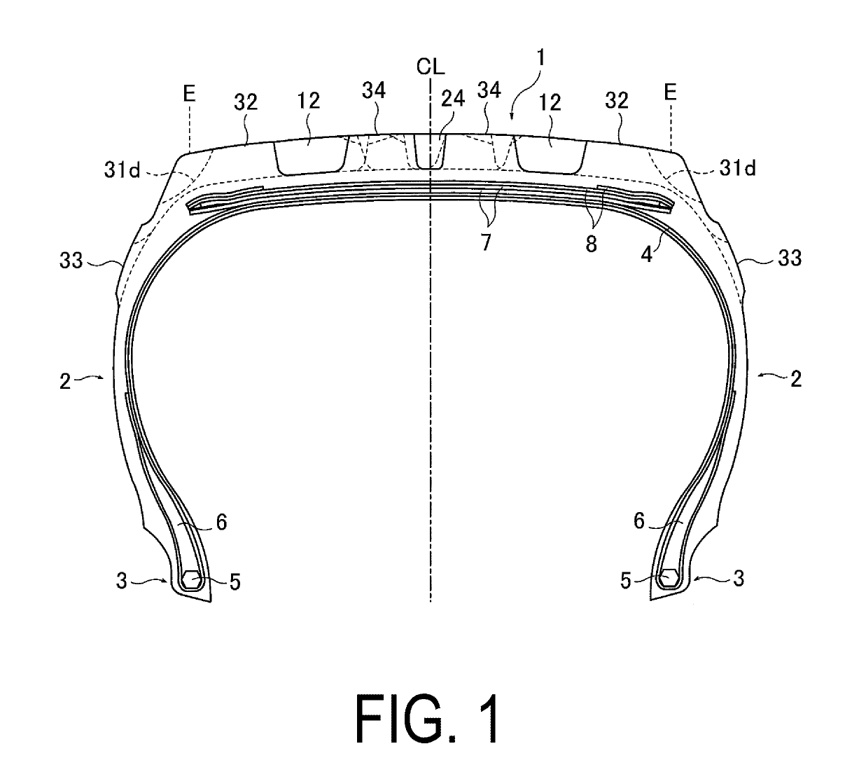

As illustrated in FIG. 1, the pneumatic tire of the present technology includes an annular tread section 1 extending in the tire circumferential direction, a pair of sidewall sections 2 disposed on both sides of the tread section 1, and a pair of bead sections 3 disposed inward of the sidewall sections 2 in the tire radial direction. Reference sign CL in FIG. 1 denotes the tire equator, and reference sign E denotes the ground contact edge.

A carcass layer 4 is mounted between the pair of left and right bead sections 3. The carcass layer 4 includes a plurality of reinforcing cords extending in the tire radial direction, and is folded back around a bead core 5 disposed in each of the bead sections 3 from a vehicle inner side to a vehicle outer side. Additionally, bead fillers 6 are disposed on the outer periphery of the bead cores 5, and each bead filler 6 is enveloped by a main body portion and a folded back portion of the carcass layer 4. In the tread section 1, a plurality of belt layers 7 (two layers in FIG. 1) is embedded in the outer peripheral side of the carcass layer 4. The belt layers 7 each include a plurality of reinforcing cords that are inclined with respect to the tire circumferential direction, and the direction of the reinforcing cords of the different layers intersect each other. In these belt layers 7, the inclination angle of the reinforcing cords with respect to the tire circumferential direction is set in a range, for example, of 10° to 40°. In addition, a plurality of belt reinforcing layers 8 (two layers in FIG. 1) is provided on the outer peripheral side of the belt layers 7. The belt reinforcing layer 8 includes organic fiber cords oriented in the tire circumferential direction. In the belt reinforcing layer 8, the angle of the organic fiber cords with respect to the tire circumferential direction is set, for example, to from 0° to 5°.

The present technology may be applied to such a general pneumatic tire, however, the cross-sectional structure thereof is not limited to the basic structure described above.

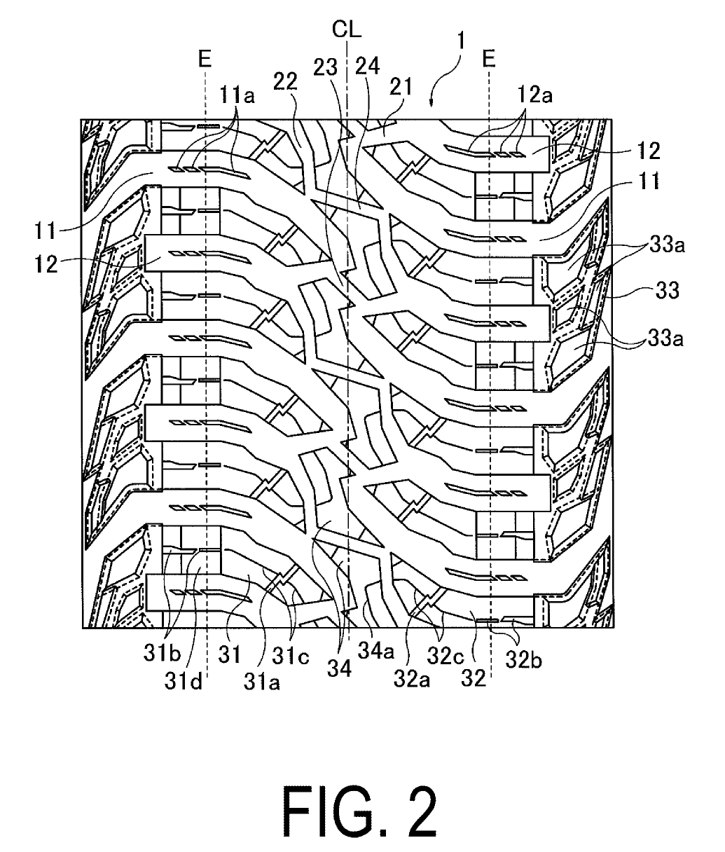

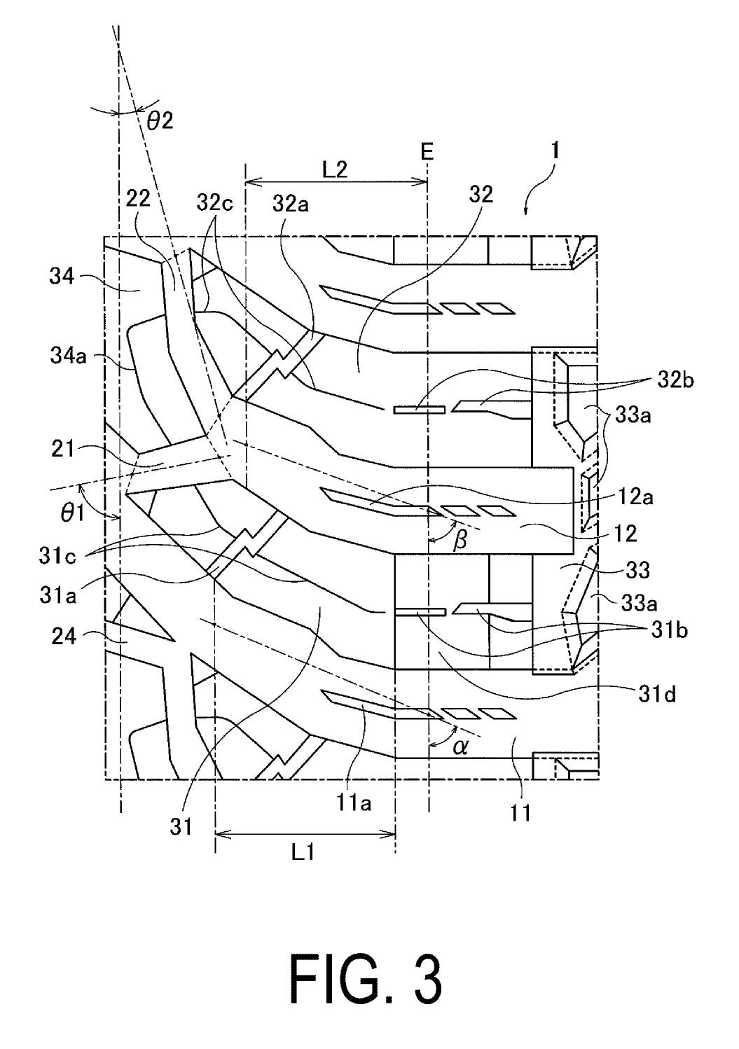

As illustrated in FIGS. 2 and 3, pluralities of each of first lug grooves 11, second lug grooves 12, first connection grooves 21, second connection grooves 22, third connection grooves 23 and fourth connection grooves 24 are provided in the tread section 1. Furthermore, pluralities of each of first shoulder blocks 31, second shoulder blocks 32, and center blocks 34 are defined by these grooves. Note that the third connection grooves 23 and the fourth connection grooves 24, and the center blocks 34 defined by a plurality of grooves including the third connection grooves 23 and the fourth connections grooves 24, are optional elements as described below, and therefore do not necessarily have to be provided.

The first lug grooves 11 are grooves that extend in the tire lateral direction in the shoulder region (region at the outer side in the tire lateral direction) of the tread section 1. In the illustrated example, the first lug grooves 11 extend substantially in the tire lateral direction in the shoulder region, and an inclination angle with respect to the tire lateral direction becomes gradually larger moving towards a tire equator CL side in the center region. The groove length of the first lug groove 11 is longer than that of a below-described second lug groove 12, and in the illustrated example, one end of the first lug groove 11 crosses over a ground contact edge E and is opened towards the outer side in the tire lateral direction, and the other end reaches the tire equator CL and terminates. In the illustrated example, projection portions 11a that project from a groove bottom and extend along the first lug groove 11 are formed at a groove bottom center near the ground contact edge E of the first lug groove 11.

Similar to the first lug grooves, the second lug grooves 12 are grooves that extend in the tire lateral direction in the shoulder region (region at the outer side in the tire lateral direction) of the tread section 1. In the illustrated example, the first lug grooves 11 extend substantially in the tire lateral direction in the shoulder region, and an inclination angle with respect to the tire lateral direction becomes gradually larger moving towards a tire equator CL side in the center region. The groove length of the second lug groove 12 is shorter than that of the above-described first lug groove 11, and in the illustrated example, one end of the second lug groove 12 terminates inside a side block 33 disposed at a position that has crossed over the ground contact edge E, and the other end terminates at a position further to the outside in the tire lateral direction than the tire equator CL. In the illustrated example, projection portions 12a that project from a groove bottom and extend along the second lug groove 12 are formed at a groove bottom center near the ground contact edge E of the second lug groove 12.

These first lug grooves 11 and second lug grooves 12 are alternately disposed along the tire circumferential direction. Furthermore, the first connection grooves 21 and the second connection grooves 22 are formed between first lug grooves 11 and second lug grooves 12 that are adjacent in the tire circumferential direction.

The first connection groove 21 is a groove that extends from a tip end portion of the first lug groove 11 to the second lug groove 12. At this time, the connection position of the first connection groove 21 with respect to the second lug groove 12 is not particularly limited. In the illustrated example, the first connection groove 21 connects to a tip end portion of the second lug groove 12. While dependent on the positional relationship between the first lug groove 11 and the second lug groove 12, the first connection groove 21 extends at an incline with respect to the tire circumferential direction. Here, an angle θ1 of the first connection groove 21 with respect to the tire circumferential direction is set larger than an angle θ2 of the below-described second connection groove 22 with respect to the tire circumferential direction.

The second connection groove 22 is a groove that extends from a tip end portion of the second lug groove 12 to the first lug groove 11. At this time, the connection position of the second connection groove 22 with respect to the first lug groove 11 is not particularly limited. In the illustrated example, the second connection groove 22 connects to a midway portion of the first lug groove 11. While dependent on the positional relationship between the first lug groove 11 and the second lug groove 12, the second connection groove 22 extends at an incline with respect to the tire circumferential direction. Here, the angle θ2 of the second connection groove 22 with respect to the tire circumferential direction is set to be smaller than the angle θ1 of the above-described first connection groove 21 with respect to the tire circumferential direction.

The first shoulder blocks 31 and the second shoulder blocks 32 are defined by these first lug grooves 11, second lug grooves 12, first connection grooves 21, and second connection grooves 22. These first shoulder blocks 31 and second shoulder blocks 32 are each defined by below-described groove combinations, and therefore are alternately disposed along the tire circumferential direction.

The first shoulder block 31 is a block that is defined by a first lug groove 11, a second lug groove 12, and a first connection groove 21. Because the first shoulder block 31 is defined by this combination of grooves, an inner end portion in the tire lateral direction of the first shoulder block 31 is disposed further to the tire equator CL side than an inner end portion in the tire lateral direction of the below-described second shoulder block 32. This first shoulder block 31 is provided with a traversal groove 31a that traverses each block while being inclined with respect to the tire circumferential direction. In the illustrated example, in addition to the traversal groove 31a, the first shoulder block 31 is also provided with a narrow groove 31b positioned on the ground contact edge E and extending in the tire lateral direction, a narrow groove 31b positioned further outward in the tire lateral direction than the ground contact edge E and extending in the tire lateral direction, and a sipe 31c extending along the longitudinal direction of the first block and intersecting the traversal groove 31a. In the illustrated example, a concave part 31d is formed at position of the ground contact edge E of the first shoulder block 31. Therefore, in the illustrated example, the ground contact edge of the first shoulder block 31 itself is positioned further inward in the tire lateral direction than the ground contact edge E (outer end portion in the tire lateral direction of the ground contact region).

The second shoulder block 32 is a block that is defined by a first lug groove 11, a second lug groove 12, and a second connection groove 22. Because the second shoulder block 32 is defined by this combination of grooves, an inner end portion in the tire lateral direction of the second shoulder block 32 is disposed further outward in the tire lateral direction than an inner end portion in the tire lateral direction of the above-described first shoulder block 31. This second shoulder block 32 is provided with a traversal groove 32a that traverses each block while being inclined with respect to the tire circumferential direction. In the illustrated example, in addition to the traversal groove 32a, the second shoulder block 32 is also provided with a narrow groove 32b positioned on the ground contact edge E and extending in the tire lateral direction, a narrow groove 32b positioned further outward in the tire lateral direction than the ground contact edge E and extending in the tire lateral direction, and a sipe 32c extending along the longitudinal direction of the first block and intersecting the traversal groove 32a. In the illustrated example, a concave part 31d like that of the first shoulder block 31 is not formed at the second shoulder block 32, and therefore the ground contact edge of the second shoulder block 32 itself matches the ground contact edge E (outer end portion in the tire lateral direction of the ground contact region).

Note that in the illustrated example, side blocks 33 are provided to the outside of these first shoulder blocks 31 and second shoulder blocks 32 in the tire lateral direction. The side block 33 is formed continuously with the first shoulder block 31 and the second shoulder block 32. Therefore, the structure of the shoulder region of the illustrated example can also be regarded to be such that the second lug groove 12 is formed at a block (a series of blocks formed from the first shoulder block 31, the second shoulder block 32, and the side block 33) defined between two first lug grooves 11, and terminates in this block. The side block 33 is present in a region that can sink into mud, etc. when driving on muddy ground, and therefore a ridged/grooved portion 33a may be optionally provided as with the illustrated example, and this ridged/grooved portion 33a may be caused to bite into the mud, etc. to thereby improve mud performance. Note that the portion of the ridged/grooved portion 33a indicated by the dotted line in the drawings is intended to indicate the boundary at which projection or indentation of the ridged/grooved portion 33a from the surface of the side block 33 begins.

The traversal grooves 31a. 32a formed in the first shoulder block 31 and the second shoulder block 32 both have a bent portion midway in the longitudinal direction and have a zigzag shape. The traversal groove 31a formed in the first shoulder block 31 has one end that communicates with a midway portion of the first lug groove 11, and the other end that communicates with a midway portion of the second lug groove 12. The traversal groove 32a formed in the second shoulder block 32 has one end that communicates with an inner end portion in the tire lateral direction of the second lug groove 12, and the other end that communicates with a midway portion of the first lug groove 11. The groove widths and groove depths of the traversal grooves 31a and 32a are smaller than those of the lug grooves and connection grooves, and the groove widths are wider than that of the sipes. More specifically, favorably, the lug grooves have a groove width of from 25 mm to 40 mm, and a groove depth of from 10 mm to 20 mm, the connection grooves have a groove width of from 5 mm to 20 mm, and a groove depth of from 10 mm to 20 mm, and the sipes have a groove width of from 0.8 mm to 1.5 mm, and a groove depth of from 2 mm to 15 mm, while in contrast, the traversal grooves 31a and 32a have a groove width of from 2 mm to 5 mm, and a groove depth of from 5 mm to 10 mm.

These first lug grooves 11, second lug grooves 12, first connection grooves 21, second connection grooves 22, first shoulder blocks 31, and second shoulder blocks 32 are respectively disposed a both sides of the tire equator CL. These first lug grooves 11, second lug grooves 12, first connection grooves 21, second connection groove 22, first shoulder blocks 31, and second shoulder blocks 32 positioned at both sides of the tire equator CL are substantially in a point symmetrical relationship with respect to points on the tire equator CL.

When the first lug grooves 11, second lug grooves 12, first connection grooves 21, second connection grooves 22, first shoulder blocks 31, and second shoulder blocks 32 are provided in this manner at both sides of the tire equator CL, third connection grooves 23 that connect the first connection grooves 21 each other can be optionally provided between first connection grooves 21 positioned at both sides of the tire equator CL. In addition, fourth connection grooves 24 that connect the second connection grooves 22 each other can be optionally provided between second connection grooves 22 positioned at both sides of the tire equator CL. In the illustrated example, respective third connection grooves 23 are formed between first connection grooves 21 that are in a point symmetrical relationship with respect to points on the tire equator CL, and respective fourth connection grooves 24 are formed between second connection grooves 22 that are in a point symmetrical relationship with respect to points on the tire equator CL, and therefore a plurality of center blocks 34 is defined on the tire equator CL by the first connection grooves 21, the second connection grooves 22, the third connection grooves 23, and the fourth connection grooves 24.

The present technology stipulates a structure of a shoulder region in the tread section, namely, a structure provided with first lug grooves 11, second lug grooves 12, first connection grooves 21, second connection grooves 22, first shoulder blocks 31, and second shoulder blocks 32, and provided with traversal grooves 31a and 32a at each of the first shoulder blocks 31 and the second shoulder blocks 32, and therefore the structure of the center region of the tread section is not particularly limited. For example, specifications may be adopted for which the third connection grooves 23 and the fourth connection grooves 24 are not provided, and rib-like land portions extending continuously in the tire circumferential direction are formed on the tire equator CL.

As described above, the first lug grooves 11, second lug grooves 12, first connection grooves 21, and second connection grooves 22 are provided, and the first shoulder blocks 31 and second shoulder blocks 32 are defined by these grooves, and therefore mud discharge performance for discharging mud, etc. from inside the grooves with good efficiency can be increased while obtaining excellent traction performance with excellent biting into the mud, etc., and mud performance can be improved. In particular, as described above, because the angle of the first connection groove 21 with respect to the tire circumferential direction is larger than the angle of the second connection groove 22 with respect to the tire circumferential direction, the traction performance of the second lug grooves 12, which have relatively low traction performance due to being shorter than the first lug grooves 11, can be compensated by the first connection grooves 21, and the mud discharge performance of the first lug grooves 11, which have relatively low mud discharge performance due to being longer than the second lug grooves 12, can be compensated by the second connection grooves 22, and the mud performance can be effectively increased. Meanwhile, traversal grooves 31a and 32a are provided for each of the first shoulder blocks 31 and the second shoulder blocks 32, and therefore the first shoulder blocks 31 and the second shoulder blocks 32 are suitably defined, a difference in rigidity between these blocks can be suppressed, and uneven wear resistance can be increased.

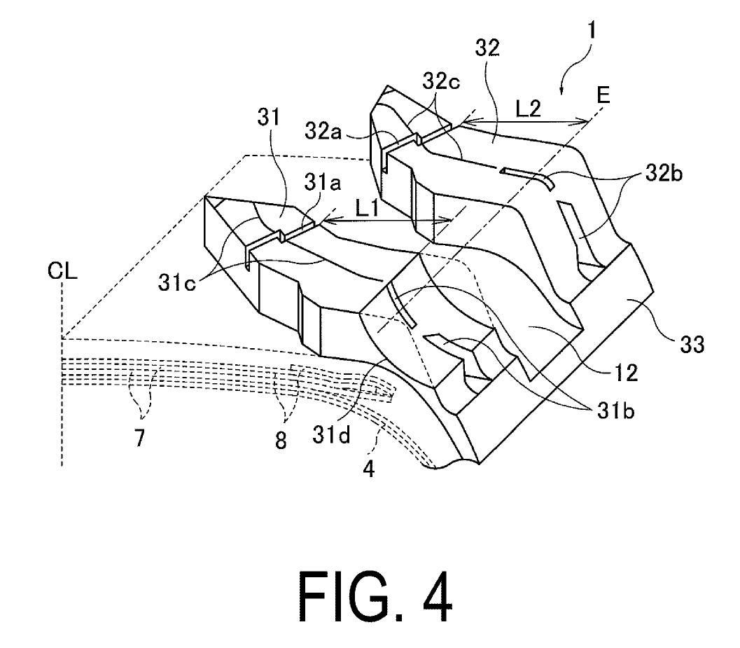

The traversal grooves 31a and 32a can be disposed at optional positions of the first shoulder blocks 31 and the second shoulder blocks 32, but are preferably disposed at positions such that the distances from an outer edge in the tire lateral direction of each block are the same. More specifically, as illustrated in FIG. 4, preferably, a distance L1 from, with respect to the first shoulder block 31, an outer edge in the tire lateral direction of the block to a point at the innermost side in the tire lateral direction of the traversal groove 31a, and a distance L2 from, with respect to the second shoulder block 32, an outer edge in the tire lateral direction of the block to a point at the innermost side in the tire lateral direction of the traversal groove 32a satisfy a relationship of L1=L2. Note that in FIG. 4, only the first shoulder block 31 and the second shoulder block 32, and portions of the side block 33 and second lug groove 12 are extracted and illustrated, and the other portions are omitted (some of the cross sections of the omitted portions are indicated by dotted lines) so that the positional relationship of the traversal grooves 31a and 32a is clear. The projection portion 12a in the second lug groove 12 and the ridged/grooved portion 33a formed at the side block 33 are also omitted.

In the illustrated example, the positions in the tire lateral direction of the traversal grooves 31a and 32a are shifted, but because the above-described concave part 31d is formed in the first shoulder block 31, and an edge of the first shoulder block 31 (end portion of the block itself when the block contacts the ground) is positioned further inward in the tire lateral direction than the ground contact edge E (namely, the edge of the second shoulder block 32), the distance L1 and the distance L2 satisfy the relationship of L1=L2. When the traversal grooves 31a and 32a are disposed in this manner, the rigidity of portions at the outer side in the tire lateral direction defined by the traversal grooves 31a and 32a of the first shoulder block 31 and the second shoulder block 32 can be made substantially equal, which is advantageous for increasing uneven wear resistance. At this time, when the distance L1 and the distance L2 are not equivalent, the balance of block rigidity cannot be optimized, and it is difficult to sufficiently increase uneven wear resistance.

Note that a concave part 31d like that of the illustrated example does not necessarily have to be provided, and therefore the configuration may be such that the positions in the tire lateral direction of the traversal grooves 31a and 32a that are formed respectively in the first shoulder block 31 and the second shoulder block 32 are simply aligned each other and thus the distance L1 and the distance L2 are the same. Preferably, the configuration is such that a concave part 31d like that of the illustrated example is provided, traversal grooves 31a and 32a formed respectively in the first shoulder block 31 and the second shoulder block 32 are disposed to be shifted in the tire lateral direction, and an edge effect (improvement in traction performance) from the traversal grooves 31a and 32a is exhibited at various locations in the tire lateral direction.

The first lug grooves 11 and the second lug grooves 12 extend in the tire lateral direction in the shoulder region of the tread section as described above, preferably, the each angle with respect to the tire circumferential direction at the ground contact edge position is 60° to 90° at the acute angle side. More specifically, as illustrated by FIG. 3, preferably, when an angle (acute angle side) of the first lug groove 11 with respect to the tire circumferential direction at the ground contact edge position is α, and an angle (acute angle side) of the second lug groove 12 with respect to the tire circumferential direction at the ground contact edge is β, each of these angles α and β is 60° to 90°. By setting the angles α and β of each lug groove in this manner, traction performance in the shoulder region can be improved, which is advantageous for increasing mud performance. At this time, when the angles α and β are smaller than 60°, sufficient traction performance cannot be obtained. Note that the angle α is an angle that is formed with respect to the tire circumferential direction by a line obtained by connecting a midpoint in the tire circumferential direction of the first lug groove 11 with respect to a point at an innermost side in the tire lateral direction of the traversal groove 31a in the first shoulder block 31 and a midpoint in the tire circumferential direction of the first lug groove 11 at a position of the ground contact edge E, and the angle β is an angle that is formed with respect to the tire circumferential direction by a line obtained by connecting a midpoint in the tire circumferential direction of the second lug groove 12 with respect to a point at an innermost side in the tire lateral direction of the traversal groove 32a in the second shoulder block 32 and a midpoint in the tire circumferential direction of the second lug groove 12 at a position of the ground contact edge E.

As described above, angles θ1 and θ2 of the first connection groove 21 and the second connection groove 22 satisfy the relationship of θ1>θ2, but preferably, the angle θ1 is set to within a range from 45° to 90°, and the angle θ2 is set to within a range from 10° to 45°. The shapes of the first connection groove 21 and the second connection groove 22 are optimized by setting the angles θ1 and θ2 in this manner, and thus such angle settings are advantageous for realizing both uneven wear resistance and mud performance in a compatible manner. Note that in the illustrated example, the groove width of the first connection groove 21 varies, and the second connection groove 22 is bent, and therefore as illustrated, the angles θ1 and θ2 are angles that are formed with respect to the tire circumferential direction by lines that connect midpoints at end portions of each groove.

As described above, although the third connection grooves 23 and the fourth connection grooves 24 are optional elements, preferably, the third connection grooves 23 and the fourth connection grooves 24 are provided, and a plurality of center blocks 34 are provided on the tire equator CL. When the third connection grooves 23 and the fourth connection grooves 24 are provided in this manner, traction performance through the use of the third connection grooves 23 and the fourth connection grooves 24 can be ensured in the center region, and therefore such a configuration is advantageous for increasing mud performance.

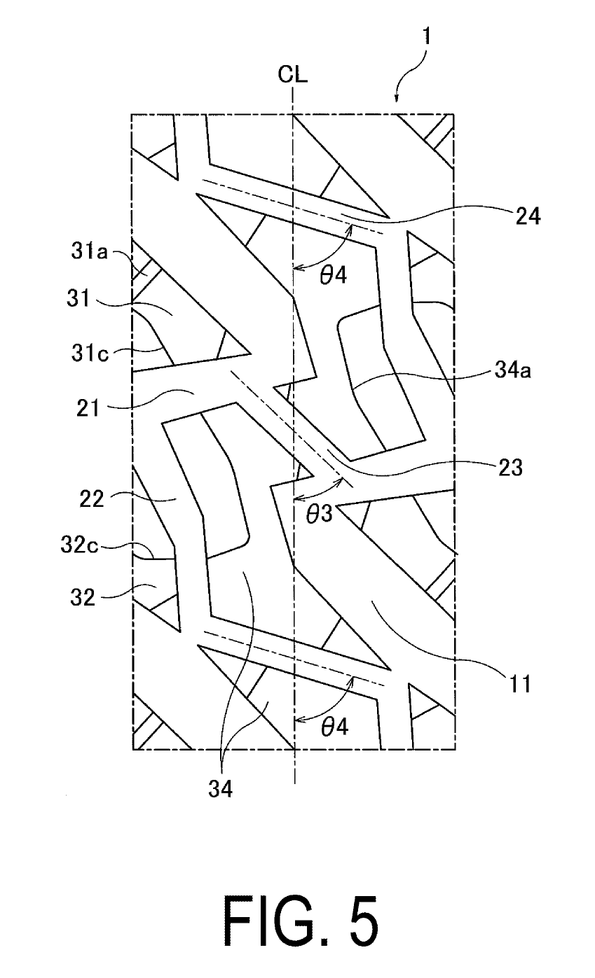

For cases in which the third connection grooves 23 and the fourth connection grooves 24 are provided, as illustrated in FIG. 5, an angle θ3 of the third connection groove 23 with respect to the tire circumferential direction is preferably smaller than an angle θ4 of the fourth connection groove 24 with respect to the tire circumferential direction. By setting the angles θ3 and θ4 of the third connection groove 23 and the fourth connection groove 24 to satisfy the relationship of θ3<θ4 in this manner, mud discharge performance can be improved with respect to the third connection grooves 23 that are connected to the first connection grooves 21, which excel in traction performance, and traction performance can be improved with respect to the fourth connection grooves 24 that are connected to the second connection grooves 22, which excel in mud discharge performance, and therefore mud performance can be exhibited at an advanced level through the combination of these first to fourth connection grooves 21 to 24.

The angles θ3 and θ4 of the third connection groove 23 and the fourth connection groove 24 can be appropriately set according to the positional relationship of the first connection groove 21 and the second connection groove 22 as long as the angles thereof satisfy the above-described magnitude relationship. However, preferably, the angle θ3 is set to within a range from 20° to 60°, and the angle θ4 is set to within a range from 60° to 90°. The shapes of grooves and blocks in the center region are optimized by setting the angles θ3 and θ4 in this manner, and thus such angle settings are advantageous for realizing both uneven wear resistance and mud performance in a compatible manner. Note that as illustrated, the angles θ3 and θ4 are angles that are formed with respect to the tire circumferential direction by a center line of each groove.

For cases in which the third connection grooves 23 and the fourth connection grooves 24 are provided, as described above, the center block 34 is defined on the tire equator CL by the first connection groove 21, the second connection groove 22, the third connection groove 23 and the fourth connection groove 24, preferably, sipes are provided in the center blocks. In particular, as illustrated in FIGS. 2 and 5, center sipes 34a extending along the second connection grooves 22 are preferably provided. Through this, the rigidity of the center block portion 34, where rigidity easily increases due to being positioned on an extension line of the second lug groove 12, which has a short groove length, is suppressed, a difference in block rigidities of the second lug groove 12 and near the second connection groove 22 is suppressed, and uneven wear resistance can be increased. Furthermore, an edge effect through the sipes can be anticipated, and therefore traction performance can also be improved.

In the example illustrated by FIG. 2, sipes are formed in each of the first shoulder blocks 31, second shoulder blocks 32, and center blocks 34. In particular, as described above, the center sipe 34a not only extends along the second connection groove 22, but also bends inside the center block 34 with one end opened to the first connection groove 21, and the other end opened to the second connection groove 22. In contrast, the first shoulder sipe 31c formed in the first shoulder block 31 extends along the second lug groove 12 and is opened at a position opposing an opening end of the center sipe 34 at the first connection groove 21 side, and the second shoulder sipe 32c formed in the second shoulder block 32 extends along the second lug groove 12 and is opened at a position opposing the opening end of the center sipe 34 at the second connection groove 22 side. Accordingly, when the first shoulder sipe 31c, the second shoulder sipe 32c and the center sipe 34a are regarded as a continuous series of sipes, this series of sipes (first shoulder sipe 31c, second shoulder sipe 32c, and center sipe 34a) is disposed to enclose the second lug groove 12. When the first shoulder block 31, the second shoulder block 32, and the center block 34 are provided in this manner, a favorable balance in the block rigidity surrounding particularly the second lug grooves 12 can be achieved, and thus such a configuration is advantageous for increasing uneven wear resistance. Furthermore, an edge effect from these sipes can be anticipated, and therefore such configuration is also advantageous for increasing traction performance.

### EXAMPLES

Nine types of pneumatic tires were prepared and used respectively as a Conventional Example 1 and Examples 1 to 8. For each tire, the tire size was LT265/70R17, the basic structure illustrated in FIG. 1 was used, the tread patterns were based on the tread pattern of FIG. 2, and the magnitude relationship of the angles of the first connection groove and the second connection groove (first/second connection groove angles), the angle α with respect to the tire circumferential direction at the traversal groove position and a ground contact edge position of the first lug groove, the angle β with respect to the tire circumferential direction at the ground contact edge position of the second lug groove, the presence or lack of third connection grooves and fourth connection grooves (presence of third/fourth connection grooves), the magnitude relationship of the angle θ3 of the third connection groove with respect to the tire circumferential direction and the angle θ4 of the fourth connection groove with respect to the tire circumferential direction (third/fourth connection groove angles), and the presence or lack of center sipes were each set as described by Table 1.

Note that in each of these examples, as illustrated, the first lug grooves were longer than the second lug grooves, and these first lug grooves and second lug grooves were alternately disposed along the tire circumferential direction. Furthermore, respective traversal grooves were formed in both the first lug grooves and the second lug grooves.

The row of Table 1 labeled “Connection groove position” indicates whether or not distances L1, L2 to the traversal groove from the edge of each block in which the traversal groove was formed were equivalent. More specifically, “L1=L2” means that the distances to the traversal groove from the edge of each block in which the traversal groove was formed were equivalent, and “L1≠L2” means that the distance to the traversal groove from the edge of each block in which the traversal groove was formed differed by block.

These nine types of pneumatic tires were evaluated for mud performance and uneven wear resistance using the evaluation methods described below. The results are also shown in Table 1.

### Mud Performance

Each test tire was mounted to a wheel having a rim size of 17×8.0, inflated to an air pressure of 450 kPa, and mounted to a pickup truck (test vehicle). A sensory evaluation of the traction performance was conducted by a test driver on a muddy road surface. The evaluation results were expressed as index values with Conventional Example 1 being assigned the index value of 100. Larger index values indicate superior mud performance.

### Wear Resistance

Each test tire was mounted to a wheel having a rim size of 17×8.0, inflated to an air pressure of 450 kPa, and mounted to a pickup truck (test vehicle). The vehicle was driven for 20000 km on dry road surfaces, after which the amount of uneven wear (heel and toe wear) was measured. The evaluation results were expressed as index values using the reciprocal of the measurement values, with the Conventional Example 1 being assigned the index value of 100. Larger index values indicate better uneven wear resistance with a smaller amount of wear.

TABLE 1-1

| | | Conventional | | | |
|---|---|---|---|---|---|
| | | Exam- | Exam- | Exam- | Exam- |
| | | ple 1 | ple 1 | ple 2 | ple 3 |
| First/second connection | | θ1 < θ2 | θ1 > θ2 | θ1 > θ2 | θ1 > θ2 |
| groove angles | | | | | |
| Connection groove position | | L1 ≠ L2 | L1 = L2 | L1 ≠ L2 | L1 = L2 |
| Angle α | ° | 75 | 75 | 75 | 55 |
| Angle β | ° | 75 | 75 | 75 | 55 |
| Presence of third/fourth | | Yes | Yes | Yes | Yes |
| connection grooves | | | | | |
| Third/fourth connection | | θ3 < θ4 | θ3 < θ4 | θ3 < θ4 | θ3 < θ4 |
| groove angles | | | | | |
| Presence of center sipes | | Yes | Yes | Yes | Yes |
| Mud performance | Index | 100 | 109 | 107 | 103 |
| | value | | | | |
| Uneven Wear | Index | 100 | 107 | 102 | 102 |
| Resistance | value | | | | |

TABLE 1-2

| | | Example 4 | Example 5 | Example 6 | Example 7 | Example 8 |
|---|---|---|---|---|---|---|
| First/second connection | | θ1 > θ2 | θ1 > θ2 | θ1 > θ2 | θ1 > θ2 | θ1 > θ2 |
| groove angles | | | | | | |
| Connection groove position | | L1 = L2 | L1 = L2 | L1 = L2 | L1 = L2 | L1 = L2 |
| Angle α | ° | 60 | 90 | 75 | 75 | 75 |
| Angle β | ° | 60 | 90 | 75 | 75 | 75 |
| Presence of third/fourth | | Yes | Yes | No | Yes | Yes |
| connection grooves | | | | | | |
| Third/fourth connection | | θ3 < θ4 | θ3 < θ4 | — | θ3 > θ4 | θ3 < θ4 |
| groove angles | | | | | | |
| Presence of center sipes | | Yes | Yes | No | Yes | No |
| Mud performance | Index | 108 | 106 | 102 | 107 | 105 |
| | value | | | | | |
| Uneven Wear Resistance | Index | 103 | 105 | 110 | 106 | 104 |
| | value | | | | | |

As is clear from Table 1, with each of the Examples 1 to 8, the mud performance and uneven wear resistance were improved in comparison to Conventional Example 1, and these performances were achieved with a good balance in a compatible manner. Note that as can be understood from Examples 1 to 5, Examples 1, 4 and 5, for which the position of the traversal grooves and the angles α and β were favorably set, exhibited excellent performance with significant improvements in mud performance and uneven wear resistance. Moreover, as can be understood from a comparison between Example 1 and Examples 6 to 8, a sufficient effect was obtained even in Example 6, which was not provided with the third connection grooves, the fourth connection grooves, and the center sipes, but a more superior effect was obtained by providing the third connection grooves, the fourth connection grooves, and the center sipes to configure preferable aspects.

1. A pneumatic tire including an annular tread section extending in a tire circumferential direction, a pair of sidewall sections disposed at both sides of the tread section, and a pair of bead sections disposed inward in a tire radial direction of the sidewall sections, the pneumatic tire comprising:
a plurality of first lug grooves and a plurality of second lug grooves shorter than the first lug grooves, the first lug grooves and the second lug grooves extending in a tire lateral direction in a shoulder region of the tread section, and being alternately disposed along the tire circumferential direction;
a first connection groove extending from a tip end portion of the first lug groove to the second lug groove; and
a second connection groove extending from a tip end portion of the second lug groove to the first lug groove, wherein
an angle of the first connection groove with respect to the tire circumferential direction is larger than an angle of the second connection groove with respect to the tire circumferential direction;
each of a plurality of first shoulder blocks is defined by the first lug groove, the second lug groove, and the first connection groove;
each of a plurality of second shoulder blocks is defined by the first lug groove, the second lug groove, and the second connection groove;
an inner end portion in the tire lateral direction of the first shoulder block is disposed closer to a tire equator side than an inner end portion in the tire lateral direction of the second shoulder block; and
each of the first shoulder blocks and second shoulder blocks includes a traversal groove traversing each block while inclining with respect to the tire circumferential direction.

2. The pneumatic tire according to claim 1, wherein
the traversal groove is disposed at a position having same distances from each outer edge in the tire lateral direction of the first shoulder block and the second shoulder block.

3. The pneumatic tire according to claim 2, wherein
the first shoulder block includes a concave part at a ground contact edge position, and
an outer edge in the tire lateral direction of the first shoulder block is positioned further inward in the tire lateral direction than the ground contact edge position.

4. The pneumatic tire according to claim 1, wherein
each angle of the first lug groove and the second lug groove with respect to the tire circumferential direction at the ground contact edge position is 60° to 90° at an acute angle side.

5. The pneumatic tire according to claim 1, further comprising:
a plurality of third connection grooves connecting first connection grooves positioned at both sides of the tire equator and
a plurality of fourth connection grooves connecting second connection grooves positioned at both sides of the tire equator, wherein;
a plurality of center blocks is defined on the tire equator by the first connection grooves, the second connection grooves, the third connection grooves, and the fourth connection grooves.

6. The pneumatic tire according to claim 5, wherein
an angle of the third connection groove with respect to the tire circumferential direction is smaller than an angle of the fourth connection groove with respect to the tire circumferential direction.

7. The pneumatic tire according to claim 6, wherein
the center block includes a center sipe extending along the second connection groove.

8. The pneumatic tire according to claim 7, wherein
the first shoulder block includes a first shoulder sipe extending along the second lug groove,
the second shoulder block includes a second shoulder sipe extending along the second lug groove, and
the center sipe, the first shoulder sipe, and the second shoulder sipe are arranged as a series of sipes to surround the second lug groove.

9. The pneumatic tire according to claim 2, wherein
each angle of the first lug groove and the second lug groove with respect to the tire circumferential direction at the ground contact edge position is 60° to 90° at an acute angle side.

10. The pneumatic tire according to claim 9, further comprising:
a plurality of third connection grooves connecting first connection grooves positioned at both sides of the tire equator and
a plurality of fourth connection grooves connecting second connection grooves positioned at both sides of the tire equator, wherein;
a plurality of center blocks is defined on the tire equator by the first connection grooves, the second connection grooves, the third connection grooves, and the fourth connection grooves.

11. The pneumatic tire according to claim 10, wherein
an angle of the third connection groove with respect to the tire circumferential direction is smaller than an angle of the fourth connection groove with respect to the tire circumferential direction.

12. The pneumatic tire according to claim 11, wherein
the center block includes a center sipe extending along the second connection groove.

13. The pneumatic tire according to claim 12, wherein
the first shoulder block includes a first shoulder sipe extending along the second lug groove,
the second shoulder block includes a second shoulder sipe extending along the second lug groove, and
the center sipe, the first shoulder sipe, and the second shoulder sipe are arranged as a series of sipes to surround the second lug groove.
